(19) United States
(12) Patent Application Publication
(10) Pub. No.: US 2020/0038878 A1
(43) Pub. Date: Feb. 6, 2020

(54) Preparation of diamagnetic nanoparticles under magnetic field

(71) Applicants: Huanchen Li, Westford, MA (US); Wendy Wang, Westford, MA (US)

(72) Inventors: Huanchen Li, Westford, MA (US); Wendy Wang, Westford, MA (US)

(21) Appl. No.: 16/531,083

(22) Filed: Aug. 4, 2019

Related U.S. Application Data
(63) Continuation-in-part of application No. 62/714,698, filed on Aug. 4, 2018.

(51) Int. Cl. B03C 1/28

(52) U.S. Cl. CPC B03C 1/288; B03C 2201/20

(57) ABSTRACT

For the purpose of preparing and isolating diamagnetic nanoparticles, we add magnetic field into the preparation processes, so that impurities that can be attracted to a magnet will go to the magnetic source. This enables diamagnetic nanoparticles get purified and contain no such impurities, so that they will be pushed away from the magnetic source.

Some preparation processes use evaporation and condensation to prepare nanoparticles. In such processes, we may control the temperature so that lower evaporating metals, such as bismuth, will evaporate, but higher evaporating metals, such as iron, will stay solid and retain a strong magnetism, so that, when we apply magnetic field, we can prepare bismuth nanoparticles that do not contain lower evaporating metals for the preparation process.

### CROSS REFERENCE TO RELATED APPLICATIONS

This application is a continuation-in-part of the provisional application Ser. No. 62/714,698 filed on Aug. 4, 2018

### BACKGROUND OF THE INVENTION

Bismuth nanoparticles suppose to be diamagnetic, however, we cannot purchase any diamagnetic Bismuth nanoparticles on the market. The Bismuth nanoparticles we have purchased contain trace amount of impurities, such as Fe and Co. These impurities are paramagnetic which neutralized the diamagnetism of the Bismuth, so that the Bismuth nanoparticles are attracted to rather than repelled by a magnet. We invented a method for preparing diamagnetic nanoparticles. This method will apply to all processes that produce diamagnetic nanoparticles.

### SUMMARY OF THE INVENTION

We invented adding a magnetic field to the preparation process for preparing diamagnetic nanoparticles. We may add a magnet or multiple magnets at one side or multiple sides of the containers so that impurities that can be attracted to the magnet will go to the magnet but diamagnetic Bismuth and Gold will be repelled away and will go to the further side so to get isolated any purified.

Other than using the magnetic field, we may also use different evaporating temperature points between metals. Bismuth has a much lower evaporating point than iron. By controlling the temperature, we can evaporate the Bismuth metal but leaving the Iron behind, so that in the condensation chamber, we can get Bismuth nanoparticles.

The inventions should be used for the preparation, isolation, and purification of diamagnetic nanoparticles/nanorods of all different kind of materials such as Bismuth, Gold, polystyrenes, etc. The inventions can also be used for getting the materials that are to be used for the preparation purified and ready for the preparation.

### DETAILED DESCRIPTION

There are many different ways to prepare Bismuth nanoparticles, such as the evaporation- condensation method as described by Panda and Wegner (Ref. 4-5).

With the evaporation-condensation method, we will add a magnet at the bottom of the evaporating chamber, preferably at the evaporating side outside of the chamber, so that when the chamber is heated, the magnet will not get too much heat. We can also add and insulation layer between the magnet and the heating source for the purpose of keep the magnet cool. When the temperature of the Bismuth reaches its evaporating point, we may stop heating the chamber so that irons and some other paramagnetic impurities will not evaporate and will be attracted to the magnetic side. We may also add a magnet to the condensation chamber, but still at the evaporating direction, so that even if some impurities do evaporated, they cannot get to the condensation production location. Only bismuth and diamagnetic impurities can get to the production condensation location, and get condensate to the membrane.

There are many other methods that prepare bismuth nanoparticles in aqueous solutions, such as Fengling et al (Ref. 2). We will pre-treat all the materials and chemicals, whether dry or in solvents, before starting the preparation by putting a strong magnet at the bottoms of all the containers that contain the materials and chemicals, then shake the container with a electric agitator or simply by hand. The magnetic field should be strong and should create great magnetic gradient so to quickly attract any impurities to that side. Once the impurities are attracted to the magnetic side, we can take the purified materials and chemicals from the opposite side by a spoon or any other tools, or just by careful pouring. Such as in Fengling's method, the sodium borohydride, ammonium bismuth citrate and the soluble starch can be put into the water, and put into a container. At the bottom of the container, we can put a magnet, then wait for some time such as 10 minutes or a few days while agitating the container, so to attract all the impurities that can be attracted to the magnet, while leaving the pure chemicals at the upper phase of the solvents. We will then take out only the upper phase and use the upper phase to do the preparation. We can also put the magnet at the bottom of the container that is being used for the preparation when the chemical reaction is going on. We may further isolate the diamagnetic nanoparticles that are already created at the upper phase.

Another embodiment would we directly put a magnet or magnets in to the materials, such as chemical powders or chemical liquids, agitate and allow the materials that can be attracted to the magnet(s) to go to the magnet(s), then separate the purified materials from the magnet(s) that have the impurities on their surface, either by taking the magnets out of the materials or by taking the materials away from the magnet(s).

We can further use this invention for the purification of diamagnetic materials or products, where, we use magnetic sources to push the diamagnetic materials or products to a location that is further away from the magnetic source(s), and then collecting the diamagnetic materials or products from that location.

With the mechanical mill method (Namita, ref. 3) or Top-down method (Mary, ref 1), we can get the metals such as Bismuth melted, then put a magnet underneath of the container that contains the melted Bismuth so to allow magnetic impurities get attracted to the bottom while the Bismuth is cooling down and crystallizing. We will take the top part of the Bismuth crystal for the milling.

Before the preparation, we should purify all the starting materials and solutions that are to be used for the preparation, and after the preparation, we should isolate the diamagnetic nanoparticles from contaminated ones. We can put the starting materials or prepared nanoparticles into a container, put a magnet at one end of the container, agitate, so to allow the impurities and the materials or nanoparticles that are contaminated by the impurities to get attracted to the magnet, while starting materials that are not contaminated will stay at the original location and, further, diamagnetic materials and nanoparticles will be pushed away to the other side, we can collect the uncontaminated materials at the original location and the diamagnetic materials and nanoparticles at the other side.

During the preparation, we can also apply magnetic field to the containers or chambers, whenever allowable, to keep the impurities at one corner.

The magnetic field should be strong, can be as high as 7 T or even much higher. And the magnetic gradient should also be big.

This invention can be used for preparing diamagnetic nanoparticles that are 1 nanometer to 100 microns in diameter.

### References

1. Mary Ealias and M P Saravanakumar, A review on the classification, characterisation, synthesis of nanoparticles and their application Mary Ealias and M P Saravanakumar 2017 IOP Conf. Ser.: Mater. Sci. Eng. 263 032019

2. Fengling Xia et al, Preparation of Bismuth Nanoparticles in Aqueous Solution and Its Catalytic Performance for the Reduction of 4-Nitrophenol, nd. Eng. Chem. Res., 2014, 53 (26), pp 10576-10582

3. Namita Rajput, METHODS OF PREPARATION OF NANOPARTICLES—A REVIEW, International Journal of Advances in Engineering & Technology, Jan., 2015.

4. “Modelling the Synthesis of Aluminum Particles by Evaporation-Condensation in an Aerosol Flow Reactor” Nanostruct. Matls., 5, 755; 1995

5. SYNTHESIS OF BISMUTH NANOPARTICLES, Journal of Aerosol Science, Vol. 31, Suppl 1, pp. 8214-8215,2000

We claim:

1. A method for the preparation diamagnetic nanoparticles comprising using a magnetic field to pull out magnetic impurities from materials involved in the preparation, and push away diamagnetic materials and nanoparticles for isolation.

2. A method for preparing diamagnetic nanoparticles according to claim 1 further comprising:
putting material(s) into a container;
putting magnet(s) into the material(s) or at one or multiple sides of the container either inside or outside of said container;
allowing impurities that can be attracted to the magnet(s) go toward said magnet(s).

3. A method for preparing diamagnetic nanoparticles according to claim 2 further comprising separating the purified material(s) that cannot be attracted to said magnet(s) from said impurities.

4. A method for preparing diamagnetic nanoparticles according to claim 2 further comprising:
allowing said magnet(s) push away diamagnetic materials or nanoparticle-products to a location; and
collecting said diamagnetic materials or nanoparticle-products from said location.

5. A method for preparing diamagnetic nanoparticles according to claim 2 further comprising:
heating the material to its melting point so to melt the material; and
use said magnet(s) to pull out magnetic impurities from the material.
